(19) United States
(12) Patent Application Publication
(10) Pub. No.: US 2021/0108701 A1
(43) Pub. Date: Apr. 15, 2021

(54) VIBRATION DAMPING DEVICE FOR VEHICLE

(71) Applicant: HONDA MOTOR CO., LTD., Tokyo (JP)

(72) Inventors: Keita TAKAESU, Saitama (JP); Seiji HAYAKAWA, Saitama (JP); Naoki SOGAWA, Saitama (JP)

(21) Appl. No.: 17/064,788

(22) Filed: Oct. 7, 2020

(30) Foreign Application Priority Data
Oct. 11, 2019 (JP) 2019-188164

(51) Int. Cl. F16F 13/10; F16F 13/30

(52) U.S. Cl. CPC F16F 13/107; F16F 13/10; B60K 5/1208; F16F 2224/041; F16F 2224/025; F16F 13/30

(57) ABSTRACT

A vibration damping device for a vehicle includes: a first attachment member attached to a first member; a second attachment member attached to a second member; a first liquid chamber and a second liquid chamber configured to change volumes according to relative displacement between the first attachment member and the second attachment member; and an orifice passage configured to cause a liquid to flow between the first liquid chamber and the second liquid chamber according to changes in the volumes of the first liquid chamber and the second liquid chamber. The liquid contains a non-Newtonian fluid whose viscosity decreases as a shear rate increases, the orifice passage includes a first communication port communicating with the first liquid chamber and a second communication port communicating with the second liquid chamber, and an opening area of the first communication port is different from an opening area of the second communication port.

### TECHNICAL FIELD

The present invention relates to a vibration damping device for a vehicle.

### BACKGROUND ART

A known vibration damping device for a vehicle damps vibration by causing a liquid to flow between plural liquid chambers via an orifice passage (for example, JP2004-324823A).

In order to change vibration damping characteristics of the vibration damping device depending on a flowing direction of the liquid, there is a configuration to provide plural orifice passages each having a check valve and switch the orifice passage through which the liquid flows depending on the flowing direction of the liquid. However, if such a configuration is adopted, the mechanism for changing the vibration damping characteristics of the vibration damping device becomes complicated, and thus the size and the manufacturing cost of the vibration damping device may be increased. In addition, a problem with durability may be caused because plural orifice passages each have a moving part such as a check valve.

### SUMMARY OF THE INVENTION

In view of such a problem of the prior art, a primary object of the present invention is to provide a vibration damping device for a vehicle that can change vibration damping characteristics depending on a flowing direction of a liquid without increasing the size and the manufacturing cost of the vibration damping device and causing a problem with durability.

To achieve such an object, one embodiment of the present invention provides a vibration damping device (1) for a vehicle, including: a first attachment member (5) attached to a first member (2); a second attachment member (6) attached to a second member (3); a first liquid chamber (10) and a second liquid chamber (11) configured to change volumes according to relative displacement between the first attachment member and the second attachment member; and an orifice passage (12) configured to cause a liquid (M) to flow between the first liquid chamber and the second liquid chamber according to changes in the volumes of the first liquid chamber and the second liquid chamber, wherein the liquid contains a non-Newtonian fluid whose viscosity decreases as a shear rate increases, the orifice passage includes a first communication port (31) communicating with the first liquid chamber and a second communication port (32) communicating with the second liquid chamber, and an opening area of the first communication port is different from an opening area of the second communication port.

According to this arrangement, the shear rate of the liquid changes depending on the flowing direction of the liquid, and thus the shear rate and the viscosity of the non-Newtonian fluid contained in the liquid also change. Accordingly, the vibration damping characteristics of the vibration damping device can be changed depending on the flowing direction of the liquid without providing plural orifice passages each having a check valve. Namely, the vibration damping characteristics of the vibration damping device can be anisotropic depending on the flowing direction of the liquid without increasing the size and the manufacturing cost of the vibration damping device and causing a problem with durability.

In the above arrangement, preferably, the opening area of the first communication port is smaller than the opening area of the second communication port, and a diameter of the orifice passage gradually increases from the first communication port to the second communication port.

According to this arrangement, it is possible to gradually change the shear rate and the viscosity of the liquid and thus to prevent the vibration damping characteristics of the vibration damping device from changing sharply.

In the above arrangement, preferably, the opening area of the first communication port is smaller than the opening area of the second communication port, and a turbulence promoting member (42, 52, 62) configured to increase a degree of turbulence of the liquid is provided in the first communication port.

According to this arrangement, it is possible to promote the turbulence of the liquid in the first communication port and thus to increase a rising amount of the shear rate of the liquid in the first communication port. Accordingly, the vibration damping characteristics of the vibration damping device can be greatly changed depending on the flowing direction of the liquid.

In the above arrangement, preferably, the turbulence promoting member includes a rotatable portion.

According to this arrangement, the turbulence promoting member can enhance turbulence promoting efficiency of the liquid.

In the above arrangement, preferably, the rotatable portion includes a propeller (44).

According to this arrangement, the turbulence promoting member can further enhance turbulence promoting efficiency of the liquid.

In the above arrangement, preferably, the turbulence promoting member includes a mesh (54).

According to this arrangement, it is possible to sufficiently promote the turbulence of the liquid by using a simple structure without a moving part.

In the above arrangement, preferably, the turbulence promoting member includes a columnar portion.

According to this arrangement, the turbulence promoting member can generate a Karman vortex street and thus promote the turbulence of the liquid.

In the above arrangement, preferably, the vibration damping device further includes: an elastically deformable first wall (7) partially defining the first liquid chamber and configured to support the first attachment member; an elastically deformable second wall (8) partially defining the second liquid chamber and attached to the second attachment member; and a partition wall (9) coupled to the first wall so as to separate the second liquid chamber from the first liquid chamber and provided with the orifice passage.

According to this arrangement, the vibration damping effect of the vibration damping device can be enhanced.

In the above arrangement, preferably, the non-Newtonian fluid is a thixotropic fluid.

According to this arrangement, the viscosity of the non-Newtonian fluid can be gradually decreased as the shear rate increases. Accordingly, it is possible to prevent the vibration damping characteristics of the vibration damping device from changing sharply.

In the above arrangement, preferably, the liquid is composed only of the non-Newtonian fluid.

In the above arrangement, preferably, the liquid is composed of both the non-Newtonian fluid and a Newtonian fluid.

Thus, according to the above arrangements, it is possible to provide a vibration damping device for a vehicle that can change vibration damping characteristics depending on a flowing direction of a liquid without increasing the size and the manufacturing cost of the vibration damping device and causing a problem with durability.

### BRIEF DESCRIPTION OF THE DRAWING(S)

FIG. 1 is a cross-sectional view of an engine mount according to an embodiment of the present invention;

FIG. 2 is a graph showing viscosity characteristics of a Newtonian fluid and a thixotropic fluid;

FIG. 3 is a schematic perspective view showing an orifice passage according to the embodiment of the present invention;

FIG. 4 is a schematic perspective view showing an orifice passage according to the first modification of the present invention;

FIG. 5 is a schematic perspective view showing an orifice passage according to the second modification of the present invention; and

FIG. 6 is a schematic perspective view showing an orifice passage according to the third modification of the present invention.

### DESCRIPTION OF THE PREFERRED EMBODIMENT(S)

In the following, with reference to the drawings, a liquid filled engine mount 1 (an example of a vibration damping device for a vehicle) according to an embodiment of the present invention will be described. Arrows U and Lo appropriately shown in the respective drawings indicate an upper side and a lower side of the engine mount 1, respectively.

### The Structure of the Engine Mount 1

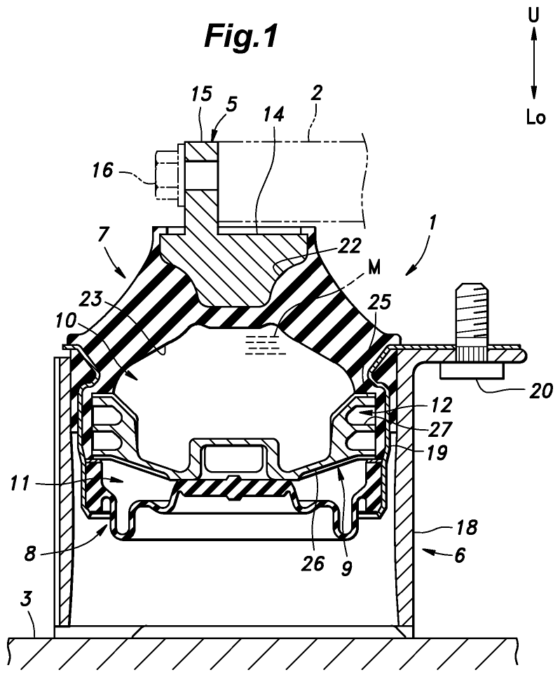

With reference to FIG. 1, the engine mount 1 is provided between an internal combustion engine 2 (an example of a first member) and a vehicle body 3 (an example of a second member) in a vehicle such as an automobile. The engine mount 1 is a component for supporting the engine 2 while damping the vibration thereof

The engine mount 1 includes a first attachment member 5 attached to the engine 2, a second attachment member 6 attached to the vehicle body 3, a first wall 7 provided between the first attachment member 5 and the second attachment member 6, a second wall 8 provided below the first wall 7, a partition wall 9 provided between the first wall 7 and the second wall 8, a first liquid chamber 10 provided above the partition wall 9, a second liquid chamber 11 provided below the partition wall 9, and an orifice passage 12 provided on an outer circumference of the partition wall 9. In the following, these components of the engine mount 1 will be described one by one.

The first attachment member 5 of the engine mount 1 is located at an upper end of the engine mount 1. The first attachment member 5 includes an engagement portion 14 and an attachment portion 15 that protrudes upward from an upper surface of the engagement portion 14. The attachment portion 15 is attached to the engine 2 by a bolt 16.

The second attachment member 6 of the engine mount 1 is located at a lower portion of the engine mount 1. The second attachment member 6 includes an outer cylinder 18 and an inner cylinder 19 that is provided on an inner circumferential side of the outer cylinder 18. An upper end of the outer cylinder 18 and an upper end of the inner cylinder 19 are attached to each other by a bolt 20. A lower portion of the outer cylinder 18 is attached to the vehicle body 3 by a bolt (not shown).

The first wall 7 of the engine mount 1 is made of rubber and is elastically deformable. An upper recess 22 that opens upward is provided in an upper portion of the first wall 7. The engagement portion 14 of the first attachment member 5 is engaged with (fits into) the upper recess 22. Accordingly, the first wall 7 supports the first attachment member 5 from below. A lower recess 23 that opens downward is provided in a lower portion of the first wall 7.

The second wall 8 of the engine mount 1 consists of the so-called diaphragm. The second wall 8 is made of rubber and is elastically deformable. An outer circumferential portion of the second wall 8 is engaged with a lower inner circumference of the inner cylinder 19 of the second attachment member 6. Thus, the second wall 8 is attached to the second attachment member 6.

The partition wall 9 of the engine mount 1 separates the second liquid chamber 11 from the first liquid chamber 10. The partition wall 9 includes a cylindrical circumferential wall 25 and a bottom wall 26 that covers a lower end of the circumferential wall 25. The circumferential wall 25 is engaged with (fits into) the lower recess 23 of the first wall 7. Accordingly, the partition wall 9 is coupled to the first wall 7. A spiral outer circumferential groove 27 is provided on an outer circumferential surface of the circumferential wall 25.

The first liquid chamber 10 of the engine mount 1 is a chamber defined by the lower recess 23 of the first wall 7 and the partition wall 9. Namely, the first liquid chamber 10 is a chamber partially defined by the first wall 7. The first liquid chamber 10 holds (is filled with) a mount liquid M (an example of a liquid).

The second liquid chamber 11 of the engine mount 1 is provided below the first liquid chamber 10. The second liquid chamber 11 is a chamber defined by the second wall 8 and the partition wall 9. Namely, the second liquid chamber 11 is a chamber partially defined by the second wall 8. The second liquid chamber 11 holds (is filled with) the mount liquid M.

The orifice passage 12 of the engine mount 1 is a passage defined by the outer circumferential groove 27 provided on the outer circumferential surface of the circumferential wall 25 of the partition wall 9 and the lower recess 23 of the first wall 7. Namely, the orifice passage 12 is a passage partially defined by the outer circumferential groove 27. The orifice passage 12 is curved in an arc shape in the axial direction (the longitudinal direction) thereof. A first end of the orifice passage 12 communicates with the first liquid chamber 10, while a second end of the orifice passage 12 communicates with the second liquid chamber 11. Namely, the first liquid chamber 10 and the second liquid chamber 11 communicate with each other via the orifice passage 12. The details of the orifice passage 12 will be described later.

### The Function of the Engine Mount 1

When the engine 2 vibrates, the first wall 7 and the second wall 8 are elastically deformed according to relative displacement between the first attachment member 5 and the second attachment member 6, and thus the volumes of the first liquid chamber 10 and the second liquid chamber 11 change. For example, when the first attachment member 5 descends with respect to the second attachment member 6, the first wall 7 and the second wall 8 are elastically deformed downward. Accordingly, the volume of the first liquid chamber 10 decreases and the volume of the second liquid chamber 11 increases. On the other hand, when the second attachment member 6 ascends with respect to the first attachment member 5, the first wall 7 and the second wall 8 are elastically deformed upward. Accordingly, the volume of the first liquid chamber 10 increases and the volume of the second liquid chamber 11 decreases.

As the volumes of the first liquid chamber 10 and the second liquid chamber 11 change in this way, the mount liquid M flows through the orifice passage 12 between the first liquid chamber 10 and the second liquid chamber 11. For example, when the volume of the first liquid chamber 10 decreases and the volume of the second liquid chamber 11 increases, the mount liquid M flows from the first liquid chamber 10 to the second liquid chamber 11. On the other hand, when the volume of the first liquid chamber 10 increases and the volume of the second liquid chamber 11 decreases, the mount liquid M flows from the second liquid chamber 11 to the first liquid chamber 10. In this way, the mount liquid M flows through the orifice passage 12 between the first liquid chamber 10 and the second liquid chamber 11, so that the vibration of the engine 2 is damped.

### The Mount Liquid M

In the present embodiment, the mount liquid M is composed only of a non-Newtonian fluid. In another embodiment, the mount liquid M may be composed of both the non-Newtonian fluid and a Newtonian fluid.

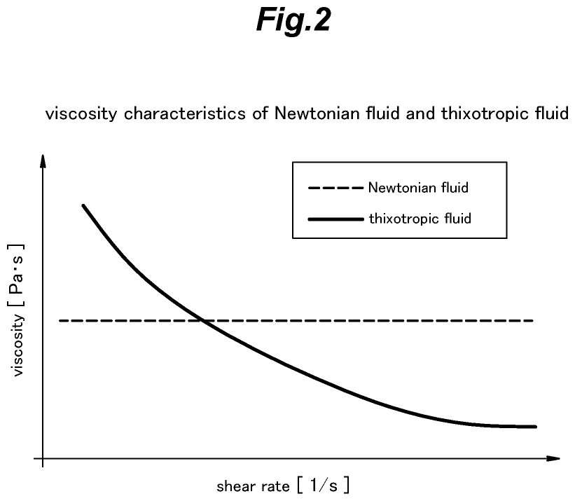

The non-Newtonian fluid that composes the mount liquid M is a thixotropic fluid. With reference to FIG. 2, the viscosity of the Newtonian fluid is constant regardless of the shear rate of the Newtonian fluid. By contrast, the viscosity of the thixotropic fluid gradually decreases as the shear rate of the thixotropic fluid increases. In another embodiment, a fluid other than the thixotropic fluid (for example, a Bingham fluid) may be used as the non-Newtonian fluid that composes the mount liquid M.

The thixotropic fluid that composes the mount liquid M is formed by mixing a thixotropy imparting agent (hereinafter abbreviated as “thixotropic agent”) into a base liquid that is composed of the Newtonian fluid. In another embodiment, the thixotropic fluid that composes the mount liquid M may contain additives in addition to the base liquid and the thixotropic agent.

The base liquid of the thixotropic fluid is formed by dissolving a glycol-based solvent (for example, ethylene glycol or propylene glycol) in water. The ethylene glycol has an effect of lowering the freezing temperature of the water, and also has a relatively low viscosity among solvents having such an effect. Accordingly, the ethylene glycol is preferable as a solvent of the base liquid. In another embodiment, the base liquid may be formed by dissolving a solvent other than the glycol-based solvent in the water or by dissolving a solvent in a liquid other than a water-based liquid (for example, an oil-based liquid).

The thixotropic agent of the thixotropic fluid is composed of an inorganic material (for example, bentonite or silica). The bentonite contains montmorillonite that has an effect of reducing temperature dependency of the characteristics of the thixotropic fluid, and thus is preferable as the thixotropic agent. In another embodiment, the thixotropic agent may be composed of an organic material (for example, a cellulose derivative or a polyether material), or may be composed of a composite material (for example, organic bentonite or calcium carbonate). If the content of the thixotropic agent in the thixotropic fluid is equal to or less than 10% by weight, the thixotropic agent can be evenly dispersed in the entire thixotropic fluid. However, the content of the thixotropic agent in the thixotropic fluid may exceed 10% by weight (for example, 20% by weight).

### The Structure of the Orifice Passage 12

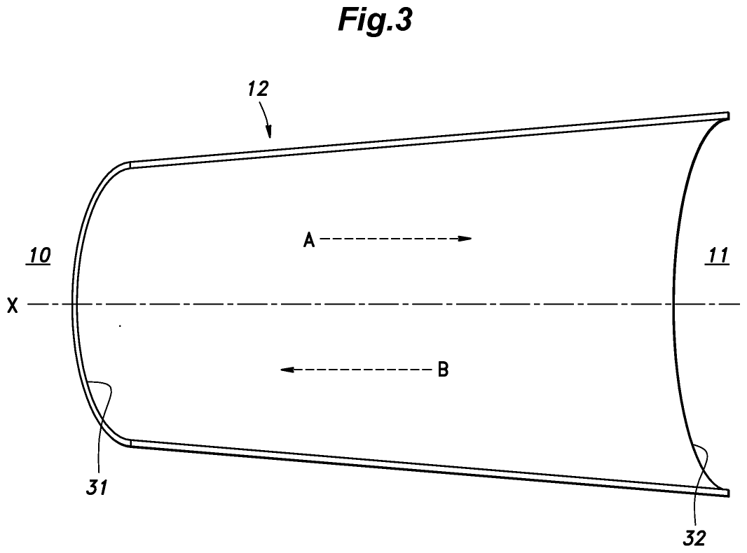

FIG. 3 shows the orifice passage 12. However, in FIG. 3, the orifice passage 12, which is actually curved in an arc shape, is schematically shown in a straight tube shape. Further, in FIG. 3, in order to clearly show the inside of the orifice passage 12, only a half of the orifice passage 12 on a far side thereof is shown. A one-dot chain line X in FIG. 3 indicates an axis (a centerline) of the orifice passage 12 (hereinafter referred to as “the axis X”). A broken-line arrow A in FIG. 3 indicates a flow of the mount liquid M from the first liquid chamber 10 to the second liquid chamber 11. A broken-line arrow B in FIG. 3 indicates a flow of the mount liquid M from the second liquid chamber 11 to the first liquid chamber 10.

A first communication port 31 communicating with the first liquid chamber 10 is provided at the first end of the orifice passage 12. A second communication port 32 communicating with the second liquid chamber 11 is provided at the second end of the orifice passage 12. A diameter of the orifice passage 12 gradually increases from the first communication port 31 to the second communication port 32. Accordingly, an opening area of the first communication port 31 is smaller than an opening area of the second communication port 32. In another embodiment, the diameter of the orifice passage 12 may gradually increase from the second communication port 32 to the first communication port 31 and thus the opening area of the first communication port 31 may be larger than the opening area of the second communication port 32. In still another embodiment, the diameter of the orifice passage 12 may be constant from the first communication port 31 to the second communication port 32, and the opening area of the first communication port 31 or the second communication port 32 may be changed by covering a part of the first communication port 31 or the second communication port 32 with a structure such as a flange.

### The Function of the Orifice Passage 12

In a case where the mount liquid M flows from the first liquid chamber 10 to the second liquid chamber 11, the mount liquid M flows through the orifice passage 12 from the first communication port 31 to the second communication port 32. At this time, the shear rate of the thixotropic fluid that composes the mount liquid M gradually decreases and thus the viscosity of the thixotropic fluid gradually increases, since the diameter of the orifice passage 12 gradually increases from the first communication port 31 to the second communication port 32.

On the other hand, in a case where the mount liquid M flows from the second liquid chamber 11 to the first liquid chamber 10, the mount liquid M flows through the orifice passage 12 from the second communication port 32 to the first communication port 31. At this time, the shear rate of the thixotropic fluid that composes the mount liquid M gradually increases and thus the viscosity of the thixotropic fluid gradually decreases, since the diameter of the orifice passage 12 gradually decreases from the second communication port 32 to the first communication port 31.

### The Effects

As described above, in the present embodiment, the opening area of the first communication port 31 is different from the opening area of the second communication port 32. Thus, the shear rate of the mount liquid M changes depending on the flowing direction of the mount liquid M, and thus the shear rate and the viscosity of the thixotropic fluid contained in the mount liquid M also change. Accordingly, the vibration damping characteristics of the engine mount 1 can be changed depending on the flowing direction of the mount liquid M without providing plural orifice passages each having a check valve. Namely, the vibration damping characteristics of the engine mount 1 can be anisotropic depending on the flowing direction of the mount liquid M without increasing the size and the manufacturing cost of the engine mount 1 and causing a problem with durability.

Further, the diameter of the orifice passage 12 gradually increases from the first communication port 31 to the second communication port 32. Accordingly, it is possible to gradually change the shear rate and the viscosity of the mount liquid M and thus to prevent the vibration damping characteristics of the engine mount 1 from changing sharply.

Further, the engine mount 1 includes the elastically deformable first wall 7 partially defining the first liquid chamber 10 and configured to support the first attachment member 5, the elastically deformable second wall 8 partially defining the second liquid chamber 11 and attached to the second attachment member 6, and the partition wall 9 coupled to the first wall 7 so as to separate the second liquid chamber 11 from the first liquid chamber 10 and provided with the orifice passage 12. Accordingly, the vibration damping effect of the engine mount 1 can be enhanced.

Further, the non-Newtonian fluid that composes the mount liquid M is the thixotropic fluid. Thus, the viscosity of the non-Newtonian fluid can be gradually decreased as the shear rate increases. Accordingly, it is possible to prevent the vibration damping characteristics of the engine mount 1 from changing sharply.

### The Modifications

In the following, preferable modifications of the present invention will be described. Descriptions of the same items as the above embodiment will be omitted.

### The First Modification

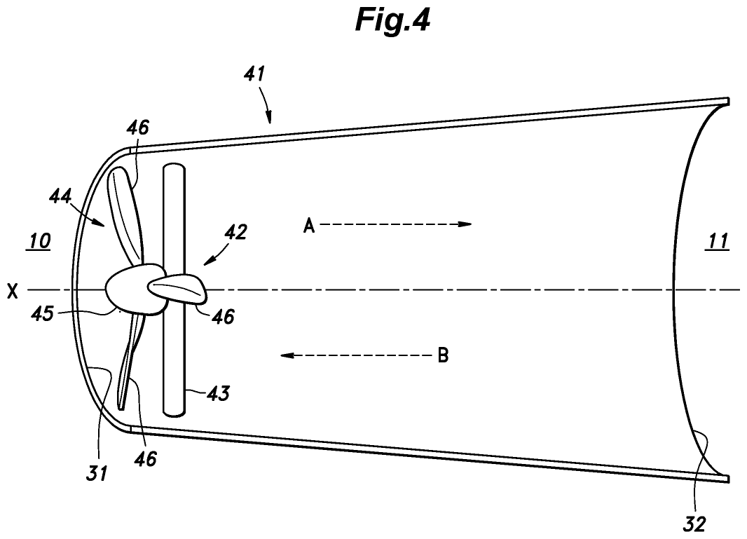

FIG. 4 shows an orifice passage 41 according to the first modification of the present invention.

A turbulence promoting member 42 configured to increase a degree of turbulence of the mount liquid M is provided in the first communication port 31 of the orifice passage 41. The turbulence promoting member 42 includes a support 43 and a propeller 44. The support 43 extends from an inner circumferential surface of the first communication port 31 in a direction orthogonal to an axis X (a centerline) of the orifice passage 41. The propeller 44 is rotatably supported by the support 43. The propeller 44 includes a hub 45 rotatably attached to the support 43 and three blades 46 radially extending from the hub 45. Each blade 46 is inclined with respect to the axis X of the orifice passage 41. In another embodiment, the propeller 44 may be fixed to the support 43. In still another embodiment, the rotatable portion of the turbulence promoting member 42 may consist of a screw.

According to the configuration of the first modification, the turbulence promoting member 42 is provided in the first communication port 31 of the orifice passage 41. Thus, it is possible to promote the turbulence of the mount liquid M in the first communication port 31 and thus to increase a rising amount of the shear rate of the mount liquid M in the first communication port 31. Accordingly, the vibration damping characteristics of the engine mount 1 can be greatly changed depending on the flowing direction of the mount liquid M. In another embodiment, unevenness (projections and recesses) may be provided on the inner circumferential surface of the first communication port 31 to promote the turbulence of the mount liquid M in the first communication port 31 instead of providing the turbulence promoting member 42.

Further, when the mount liquid M flows between the first liquid chamber 10 and the second liquid chamber 11 via the orifice passage 41, the propeller 44 of the turbulence promoting member 42 rotates. Accordingly, the turbulence promoting member 42 can enhance turbulence promoting efficiency of the mount liquid M.

### The Second Modification

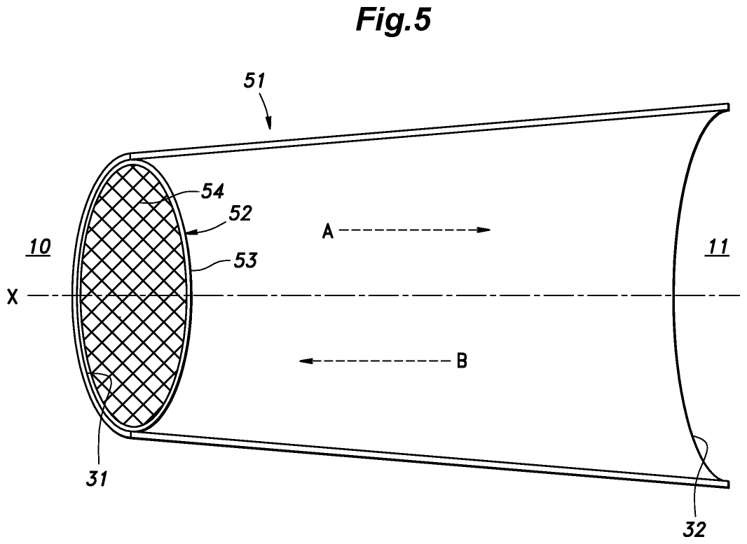

FIG. 5 shows an orifice passage 51 according to the second modification of the present invention.

A turbulence promoting member 52 configured to increase a degree of the turbulence of the mount liquid M is provided in the first communication port 31 of the orifice passage 51. The turbulence promoting member 52 includes an annular frame 53 fitted into an inner circumferential surface of the first communication port 31 and a mesh 54 attached to the frame 53.

According to the configuration of the second modification, the turbulence promoting member 52 is provided in the first communication port 31 of the orifice passage 51. Thus, it is possible to promote the turbulence of the mount liquid M in the first communication port 31 and thus to increase a rising amount of the shear rate of the mount liquid M in the first communication port 31. Accordingly, the vibration damping characteristics of the engine mount 1 can be greatly changed depending on the flowing direction of the mount liquid M.

Further, when the mount liquid M flows between the first liquid chamber 10 and the second liquid chamber 11 via the orifice passage 51, the mount liquid M passes through the mesh 54 of the turbulence promoting member 52, so that the turbulence of the mount liquid M is promoted. Accordingly, it is possible to sufficiently promote the turbulence of the mount liquid M by using a simple structure without a moving part.

### The Third Modification

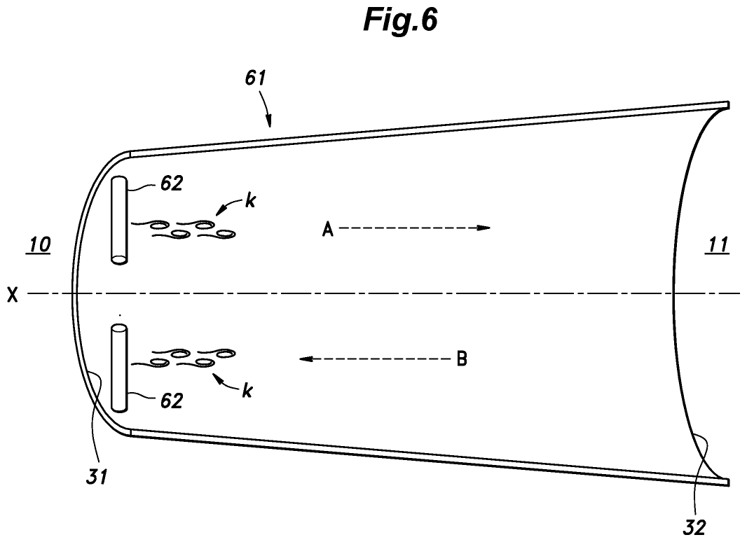

FIG. 6 shows an orifice passage 61 according to the third modification of the present invention.

Plural turbulence promoting members 62 configured to increase a degree of turbulence of the mount liquid M is provided in the first communication port 31 of the orifice passage 61. Each turbulence promoting member 62 extends from an inner circumferential surface of the first communication port 31 in a direction orthogonal to an axis X (a centerline) of the orifice passage 61. The entirety of each turbulence promoting member 62 is formed in a columnar shape. In another embodiment, only a part of each turbulence promoting member 62 may be formed in a columnar shape.

According to the configuration of the third modification, the turbulence promoting members 62 are provided in the first communication port 31 of the orifice passage 61. Thus, it is possible to promote the turbulence of the mount liquid M in the first communication port 31 and thus to increase a rising amount of the shear rate of the mount liquid M in the first communication port 31. Accordingly, the vibration damping characteristics of the engine mount 1 can be greatly changed depending on the flowing direction of the mount liquid M.

Further, when the mount liquid M flows between the first liquid chamber 10 and the second liquid chamber 11 via the orifice passage 61, the mount liquid M passes by each turbulence promoting member 62, so that each turbulence promoting member 62 generates a Karman vortex street K (see FIG. 6). Accordingly, it is possible to promote the turbulence of the mount liquid M.

### Other Modifications

In the above embodiment, the orifice passage 12 is curved in an arc shape in the axial direction thereof. In another embodiment, the orifice passage 12 may extend linearly in the axial direction thereof

In the above embodiment, the engine mount 1 that supports the engine 2 is provided as an example of the vibration damping device for a vehicle. In another embodiment, a motor mount that supports a motor may be provided as an example of the vibration damping device for a vehicle, or a shock absorber used for a suspension may be provided as an example of the vibration damping device for a vehicle. Namely, the vibration damping device for a vehicle according to the present invention can be applied to any place in a vehicle where the vibration should be damped.

Concrete embodiments of the present invention have been described in the foregoing, but the present invention should not be limited by the foregoing embodiments and various modifications and alterations are possible within the scope of the present invention.

1. A vibration damping device for a vehicle, comprising:
a first attachment member attached to a first member;
a second attachment member attached to a second member;
a first liquid chamber and a second liquid chamber configured to change volumes according to relative displacement between the first attachment member and the second attachment member; and
an orifice passage configured to cause a liquid to flow between the first liquid chamber and the second liquid chamber according to changes in the volumes of the first liquid chamber and the second liquid chamber,
wherein the liquid contains a non-Newtonian fluid whose viscosity decreases as a shear rate increases,
the orifice passage includes a first communication port communicating with the first liquid chamber and a second communication port communicating with the second liquid chamber, and
an opening area of the first communication port is different from an opening area of the second communication port.

2. The vibration damping device according to claim 1, wherein the opening area of the first communication port is smaller than the opening area of the second communication port, and
a diameter of the orifice passage gradually increases from the first communication port to the second communication port.

3. The vibration damping device according to claim 1, wherein the opening area of the first communication port is smaller than the opening area of the second communication port, and
a turbulence promoting member configured to increase a degree of turbulence of the liquid is provided in the first communication port.

4. The vibration damping device according to claim 3, wherein the turbulence promoting member includes a rotatable portion.

5. The vibration damping device according to claim 4, wherein the rotatable portion includes a propeller.

6. The vibration damping device according to claim 3, wherein the turbulence promoting member includes a mesh.

7. The vibration damping device according to claim 3, wherein the turbulence promoting member includes a columnar portion.

8. The vibration damping device according to claim 1, further comprising:
an elastically deformable first wall partially defining the first liquid chamber and configured to support the first attachment member;
an elastically deformable second wall partially defining the second liquid chamber and attached to the second attachment member; and
a partition wall coupled to the first wall so as to separate the second liquid chamber from the first liquid chamber and provided with the orifice passage.

9. The vibration damping device according to claim 1, wherein the non-Newtonian fluid is a thixotropic fluid.

10. The vibration damping device according to claim 1, wherein the liquid is composed only of the non-Newtonian fluid.

11. The vibration damping device according to claim 1, wherein the liquid is composed of both the non-Newtonian fluid and a Newtonian fluid.
